(19) United States
(12) Patent Application Publication
(10) Pub. No.: US 2005/0108936 A1
(43) Pub. Date: May 26, 2005

(54) Method to improve manufactured seed germination

(76) Inventors: Jeffrey E. Hartle, Tacoma, WA (US); William C. Carlson, Olympia, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 10/982,252

(22) Filed: Nov. 4, 2004

Related U.S. Application Data
(60) Provisional application No. 60/525,243, filed on Nov. 25, 2003.

(51) Int. Cl. A01C 1/06

(52) U.S. Cl. 47/57.6

(57) ABSTRACT

The invention provides methods for improving the germination of manufactured seeds. The methods comprise the step of inserting a plant embryo having a shoot end into a shoot restraint comprising an interior surface, wherein at least one of the interior surface of the shoot restraint and the plant embryo is contacted with a hydrated gel before or after inserting the plant embryo into the shoot restraint. The hydrated gel may comprise nutrients for the plant embryo. Another aspect of the invention provides manufactured seeds comprising a hydrated gel disposed between the shoot restraint and the plant embryo.

### CROSS REFERENCE TO RELATED APPLICATION

The present application claims the benefit of U.S. Provisional Application No. 60/525,243, filed Nov. 25, 2003.

### FIELD OF THE INVENTION

The invention relates to methods for improving the germination of manufactured seeds containing plant embryos.

### BACKGROUND OF THE INVENTION

It is often desirable to plant large numbers of genetically identical plants that have been selected to have advantageous properties, but in many cases it is not feasible to produce such plants using standard breeding techniques. In vitro culture of somatic or zygotic plant embryos can be used to produce large numbers of genetically identical embryos that have the capacity to develop into normal plants. However, the resulting embryos lack the protective and nutritive structures found in natural botanic seeds that shelter the plant embryo inside the seed from the harsh soil environment and nurture the embryo during the critical stages of sowing and germination. Attempts have been made to provide such protective and nutritive structures by using manufactured seeds, but so far germination from manufactured seeds is less successful than from natural seeds.

There is a need for an improved manufactured seed that more closely mimics the function of natural seeds to provide a large number of normal germinants. The present invention addresses this and other needs.

### SUMMARY OF THE INVENTION

The invention provides methods for improving the germination of manufactured seeds. The methods comprise the step of inserting a plant embryo having a shoot end into a shoot restraint comprising an interior surface, wherein at least one of the interior surface of the shoot restraint and the plant embryo is contacted with a hydrated gel before or after inserting the plant embryo into the shoot restraint. The hydrated gel may comprise nutrients for the plant embryo.

In some embodiments, at least one of the interior surface of the shoot restraint and the plant embryo is contacted with a hydrated gel before inserting the plant embryo into the shoot restraint. For example, the interior surface of the shoot restraint may be contacted with the hydrated gel before inserting the plant embryo into the contacted shoot restraint. Thus, the method may comprise the steps of: (a) adding a liquid hydrated gel solution to the interior surface of the shoot restraint; (b) allowing the liquid hydrated gel solution to set; (c) coring a cavity into the hydrated gel; and (d) inserting the plant embryo into the cavity in the hydrated gel.

Alternatively or additionally, at least part of the plant embryo is contacted with the hydrated gel before inserting the plant embryo into the shoot restraint. In some embodiments, only the shoot end of the plant embryo, for example the cotyledons, is contacted with the hydrated gel. For example, the method may comprise the steps of: (a) contacting the cotyledons of a plant embryo with a liquid hydrated gel solution; (b) allowing the liquid hydrated gel solution to set; and (c) inserting the contacted plant embryo into the shoot restraint.

In some embodiments, at least one of the interior surface of the shoot restraint and the plant embryo is contacted with a hydrated gel after inserting the plant embryo into the shoot restraint.

The methods of the invention are applicable to somatic or zygotic embryos from any plant species, including conifers. For example, the plant embryo may be a conifer somatic embryo, such as a Douglas-fir somatic embryo or a loblolly pine somatic embryo.

Another aspect of the invention provides manufactured seeds comprising a shoot restraint and a plant embryo having a shoot end, wherein at least the shoot end of the plant embryo is disposed within the shoot restraint and wherein a hydrated gel is disposed between the shoot restraint and the plant embryo.

### DETAILED DESCRIPTION OF THE PREFERRED EMBODIMENT

Unless specifically defined herein, all terms used herein have the same meaning as they would to one skilled in the art of the present invention.

Unless stated otherwise, all concentration values that are expressed as percentages are weight per volume percentages.

In a first aspect, the invention provides methods for improving the germination of manufactured seeds. The methods of the first aspect comprise the step of inserting a plant embryo having a shoot end into a shoot restraint comprising an interior surface, wherein at least one of the interior surface of the shoot restraint and the plant embryo is contacted with a hydrated gel before or after inserting the plant somatic embryo into the shoot restraint.

As used herein, “a plant embryo” refers to either a zygotic embryo or a somatic embryo from a plant. A zygotic plant embryo is an embryo found inside a botanic seed produced by sexual reproduction. An exemplary method for producing plant zygotic embryos suitable for use in the methods of the invention is described in EXAMPLE 2, below. A somatic embryo is an embryo produced by culturing totipotent plant cells such as meristematic tissue under laboratory conditions in which the cells comprising the tissue are separated from one another and urged to develop into minute complete embryos. Alternatively, somatic embryos can be produced by inducing “cleavage polyembryogeny” of zygotic embryos. Methods for producing plant somatic embryos suitable for use in the methods of the invention are standard in the art and have been previously described (see, e.g., U.S. Pat. Nos. 4,957,866; 5,034,326; 5,036,007; 5,041,382; 5,236,841; 5,294,549; 5,482,857; 5,563,061; and 5,821,126). For example, plant tissue may be cultured in an initiation medium that includes hormones to initiate the formation of embryogenic cells, such as embryonic suspensor masses that are capable of developing into somatic embryos. The embryogenic cells may then be further cultured in a maintenance medium that promotes establishment and multiplication of the embryogenic cells. Subsequently, the multiplied embryogenic cells may be cultured in a development medium that promotes the development of somatic embryos, which may further be subjected to post-development treatments such as cold-treatments. The somatic embryos used in the methods of the invention have completed the development stage of the somatic embryogenesis process. They may also have been subjected to one or more post-development treatments. The use of cold-treated somatic embryos in the methods of the invention is described in EXAMPLES 2-4.

Typically, the plant embryos used in the invention have a shoot end and a root end. In some species of plants, the shoot end includes one or more cotyledons (leaf-like structures) at some stage of development. Plant embryos suitable for use in the methods of the invention may be from any plant species, such as dicotyledonous or monocotyledonous plants, gymnosperms, etc.

In addition to a plant embryo, a manufactured seed typically comprises a manufactured seed coat, a nutritive medium, and a shoot restraint. A “manufactured seed coat” refers to a structure analogous to a natural seed coat that protects the plant embryo and other internal structures of the manufactured seed from mechanical damage, desiccation, from attack by microbes, fungi, insects, nematodes, birds, and other pathogens, herbivores, and pests, among other functions.

The manufactured seed coat may be fabricated from a variety of materials including, but not limited to, cellulosic materials, glass, plastic, moldable plastic, cured polymeric resins, paraffin, waxes, varnishes, and combinations thereof such as a wax-impregnated paper. The materials from which the seed coat is made are generally non-toxic and provide a degree of rigidity. The seed coat can be biodegradable, although typically the seed coat remains intact and resistant to penetration by plant pathogens until after emergence of the germinating embryo.

The manufactured seed coat can include a “shell” that has an opening or orifice that is covered or otherwise occluded by a lid and that contains a plant embryo. Alternatively, in place of an orifice, the shell can include a region that is thin or weakened relative to other regions of the shell. The covered orifice or thinner or weakened portion has a lower burst strength than the rest of the shell. Thus, a germinating embryo generally emerges from the manufactured seed coat by penetrating through the opening or thinner or weaker portion of the shell. The shell is generally sufficiently rigid to provide mechanical protection to the embryo, for example, during sowing, and is substantially impermeable to gases, water, and soil microbes. Typically, the radicle end of the embryo is oriented toward the opening or weaker area of the shell to facilitate protrusive growth of the primary root of the germinating embryo from the manufactured seed.

The seed coat may lack an opening or weakened or thin section, as long as it does not prevent the embryo germinating from within from growing out of the manufactured seed without fatal or debilitating injury to the tissue. To this end, polymeric materials having a high dry strength and low wet strength can be used. The seed coat can also be so constructed that it forms a self-breaking capsule (e.g., a capsule that is melted by depolymerization) or that it breaks apart easily upon application of an outwardly protrusive force from inside the manufactured seed but is relatively resistant to compressive forces applied to the outside of the seed coat (see, e.g., Japanese Patent Application No. JP 59102308; Redenbaugh (1993) In: Redenbaugh (ed.), Synseeds: Application of Synthetic Seeds to Crop Improvement, Chapter 1, CRC Press, Boca Raton, Fla.).

The manufactured seed coat may have two or more layers, each having the same or a different composition. For example, the innermost layer may include a relatively compliant and water-impermeable cellulosic material and the outer layer can comprise a polymeric material having a high dry strength and a low wet strength. Alternatively, the inner layer may include a rigid shape such as an open-ended cylinder, where at least a portion of the open end(s) is covered with an outer-layer material having a high dry strength and a low wet strength.

The manufactured seed coat may comprise a relatively compliant cellulosic or analogous material, shaped to at least partially conform to the shape of the nutritive medium and/or shoot restraint to be disposed therein. The manufactured seed coat may have at least one tapered end terminating with an orifice, which may be covered with a lid.

Additives such as antibiotics, and plant-growth regulators may be added to the manufactured seed coat, for example, by incorporation into the material forming one or more of the layers of the seed coat or by coating or otherwise treating the layer(s) with the additive by conventional means.

As used herein, a “nutritive medium” refers to a source of nutrients, such as vitamins, minerals, carbon and energy sources, and other beneficial compounds used by the embryo during germination. Thus, the nutritive medium is analogous to the gametophyte of a natural seed. A nutritive medium according to the invention may include a substance that causes the medium to be a semisolid or have a congealed consistency under normal environmental condition. Typically, the nutritive medium is in the form of a hydrated gel. A “gel” is a substance that is prepared as a colloidal solution and that will, or can be caused to, form a semisolid material. Such conversion of a liquid gel solution into a semisolid material is termed herein “curing” or “setting” of the gel. A “hydrated gel” refers to a water-containing gel. Such gels are prepared by first dissolving in water (where water serves as the solvent, or “continuous phase”) a hydrophilic polymeric substance (serving as the solute, or “disperse phase”) that, upon curing, combines with the continuous phase to form the semisolid material. Thus, the water becomes homogeneously associated with the solute molecules without experiencing any substantial separation of the continuous phase from the disperse phase. However, water molecules can be freely withdrawn from a cured hydrated gel, such as by evaporation or imbibition by a germinating embryo. When cured, these gels have the characteristic of compliant solids, like a mass of gelatin, where the compliance becomes progressively less and the gel becomes more “solid” to the touch as the relative amount of water in the gel is decreased.

In addition to being water-soluble, suitable gel solutes are neither cytotoxic nor substantially phytotoxic. As used herein, a “substantially non-phytotoxic” substance is a substance that does not interfere substantially with normal plant development, such as by killing a substantial number of plant cells, substantially altering cellular differentiation or maturation, causing mutations, disrupting a substantial number of cell membranes or substantially disrupting cellular metabolism, or substantially disrupting other process.

Candidate gel solutes include, but are not limited to, the following: sodium alginate, agar, agarose, amylose, pectin, dextran, gelatin, starch, amylopectin, modified celluloses such as methylcellulose and hydroxyethylcellulose, and polyacrylamide. Other hydrophilic gel solutes can also be used, so long as they possess similar hydration and gelation properties and lack of toxicity.

Gels are typically prepared by dissolving a gel solute, usually in fine particulate form, in water to form a gel solution. Depending upon the particular gel solute, heating is usually necessary, sometimes to boiling, before the gel solute will dissolve. Subsequent cooling will cause many gel solutions to reversibly “set” or “cure” (become gelled). Examples include gelatin, agar, and agarose. Such gel solutes are termed “reversible” because reheating cured gel will re-form the gel solution. Solutions of other gel solutes require a “complexing” agent which serves to chemically cure the gel by crosslinking gel solute molecules. For example, sodium alginate is cured by adding calcium nitrate (Ca(NO₃)₂) or salts of other divalent ions such as, but not limited to, calcium, barium, lead, copper, strontium, cadmium, zinc, nickel, cobalt, magnesium, and iron to the gel solution. Many of the gel solutes requiring complexing agents become irreversibly cured, where reheating will not re-establish the gel solution.

The concentration of gel solute required to prepare a satisfactory gel according to the present invention varies depending upon the particular gel solute. For example, a useful concentration of sodium alginate is within a range of about 0.5% w/v to about 2.5% w/v, preferably about 0.9% w/v to 1.5% w/v. A useful concentration of agar is within a range of about 0.8% w/v to about 2.5% w/v, preferably about 1.8% w/v. Gel concentrations up to about 24% w/v have been successfully employed for other gels. In general, gels cured by complexing require less gel solute to form a satisfactory gel than “reversible” gels.

The nutritive medium typically comprises one or more carbon sources, vitamins, and minerals. Suitable carbon sources include, but are not limited to, monosaccharides, disaccharides, and/or starches. The nutritive medium may also comprise amino acids, an adsorbent composition, and a smoke suspension. Suitable amino acids may include amino acids commonly found incorporated into proteins as well as amino acids not commonly found incorporated into proteins, such as argininosuccinate, citrulline, canavanine, ornithine, and D-steroisomers. Suitable adsorbent compositions include, but are not limited to, charcoal, polyvinyl polypyrolidone, and silica gels. A suitable smoke suspension contains one or more compounds generated through the process of burning organic matter, such as wood or other cellulosic material. Solutions containing these by-products of burning organic matter may be generated by burning organic matter, washing the charred material with water, and collecting the water. Solutions may also be obtained by heating the organic matter and condensing and diluting volatile substances released from such heating. Certain types of smoke suspensions may be purchased from commercial suppliers, for example, Wright's Concentrated Hickory Seasoning Liquid Smoke (B&G foods, Inc. Roseland, N.J. 07068). Smoke suspension may be incorporated into the nutritive medium in any of various forms. For instance, smoke suspension may be incorporated as an aerosol, a powder, or as activated clay. An exemplary concentration of Wright's Concentrated Hickory Seasoning Liquid Smoke liquid smoke suspension, if present, is between 0.0001 ml and 1 ml of smoke suspension per liter of medium. The nutritive medium may also include one or more compounds involved in nitrogen metabolism, such as urea or polyamines.

The nutritive medium may include oxygen-carrying substances to enhance both the absorption of oxygen and the retention of oxygen by the nutritive medium, thereby allowing the medium to maintain a concentration of oxygen that is higher than would otherwise be present in the medium solely from the absorption of oxygen from the atmosphere. Exemplary oxygen-carrying substances are described in U.S. Pat. No. 5,564,224, herein incorporated by reference.

The nutritive medium may also contain hormones. Suitable hormones include, but are not limited to, abscisic acid, cytokinins, auxins, and gibberellins. Abscisic acid is a sesquiterpenoid plant hormone that is implicated in a variety of plant physiological processes (see, e.g., Milborrow (2001) J. Exp. Botany 52: 1145-1164; Leung & Giraudat (1998) Ann. Rev. Plant Physiol. Plant Mol. Biol. 49: 199-123). Auxins are plant growth hormones that promote cell division and growth. Exemplary auxins for use in the germination medium include, but are not limited to, 2,4-dichlorophenoxyacetic acid, indole-3-acetic acid, indole-3-butyric acid, naphthalene acetic acid, and chlorogenic acid. Cytokinins are plant growth hormones that affect the organization of dividing cells. Exemplary cytokinins for use in the germination medium include, but are not limited to, e.g., 6-benzylaminopurine, 6-furfurylaminopurine, dihydrozeatin, zeatin, kinetin, and zeatin riboside. Gibberellins are a class of diterpenoid plant hormones (see, e.g., Krishnamoorthy (1975) Gibberellins and Plant Growth, John Wiley & Sons). Representative examples of gibberellins useful in the practice of the present invention include gibberellic acid, gibberellin 3, gibberellin 4 and gibberellin 7. An example of a useful mixture of gibberellins is a mixture of gibberellin 4 and gibberellin 7 (referred to as gibberellin 4/7), such as the gibberellin 4/7 sold by Abbott Laboratories, Chicago, Ill.

When abscisic acid is present in the nutritive medium, it is typically used at a concentration in the range of from about 1 mg/L to about 200 mg/L. When present in the nutritive medium, the concentration of gibberellin(s) is typically between about 0.1 mg/L and about 500 mg/L. Auxins may be used, for example, at a concentration of from 0.1 mg/L to 200 mg/L. Cytokinins may be used, for example, at a concentration of from 0.1 mg/L to 100 mg/L.

Exemplary nutritive media are described in U.S. Pat. No. 5,687,504 and in U.S. application Ser. No. 10/371,612, herein incorporated by reference. A representative nutritive medium is NM1, the composition of which is set forth in Table 1 below.

As used herein, a “shoot restraint” refers to a porous structure within a manufactured seed with an interior surface for contacting and surrounding at least the shoot end of a plant embryo and that resists penetration by the shoot end during germination. The shoot restraint prevents the shoot end of the embryo, such as the cotyledons, from growing into and becoming entrapped in the nutritive medium. The shoot restraint is porous to allow access of the embryo to water, nutrients, and oxygen. The shoot restraint may be fabricated from any suitable material, including, but not limited to, glassy, metal, elastomeric, ceramic, clay, plaster, cement, starchy, putty-like, synthetic polymeric, natural polymeric, and adhesive materials. Exemplary shoot restraints are described in U.S. Pat. No. 5,687,504, herein incorporated by reference.

In the methods of the invention, all or only part of the plant embryo may be inserted into the shoot restraint. Typically, at least the shoot end of the plant embryo is inserted into the shoot restraint. The methods of the invention for improving germination of manufactured seeds comprise contacting at least one of the interior surface of the shoot restraint and the plant embryo with a hydrated gel before or after inserting the plant embryo into the shoot restraint. The surface area of nutrient uptake in a manufactured seed is limited to the area of the plant embryo that is in direct contact with the interior surface of the shoot restraint. During germination of conifer embryos, the cotyledons have been found to be the primary organs for nutrient uptake (Brown & Gifford (1958) Plant Physiol. 33:57-64). The methods of the invention provide a film of hydrated gel at the interface of the shoot end of the plant embryo (e.g., the cotyledons) and the interior surface of the shoot restraint. Without being bound to any particular theory of operation, the hydrated gel may increase the surface area available for the uptake of nutrients, thereby improving germination and organ elongation.

Exemplary embodiments of hydrated gels for use in the methods are as described above for the nutritive medium. In some embodiments, the hydrated gel comprises only gel solutes and water, as described in EXAMPLE 2. An exemplary embodiments of a hydrated gel comprising only gel solutes and water is HG1, the composition of which is set forth in Table 1. In some embodiments, the hydrated gel may contain other substances such as plant nutrients, as described in EXAMPLES 2-4. Nutrients and other substances that are suitable for inclusion in the hydrated gel used in the methods of the invention are as described above for the nutritive media. An exemplary hydrated gel comprising nutrients and other substances useful in the second step of the methods of the invention is NM1, the composition of which is described in Table 1.

In the second step of the methods, either the interior surface of the shoot restraint or the plant embryo, or both, may be contacted with the hydrated gel. Thus, in some embodiments, the interior surface of the shoot restraint may be contacted with the hydrated gel, as described in EXAMPLES 2-4. Embodiments in which the plant embryo is contacted with the hydrated gel are also described in EXAMPLES 2-4. In some embodiments, only part of the plant embryo is contacted with the hydrated gel. For example, the cotyledons of a somatic or zygotic embryo may be contacted with a hydrated gel, as described in EXAMPLES 2-4. Embodiments in which both the interior surface of the shoot restraint and the plant embryo are contacted with the hydrated gel are described in EXAMPLES 3 and 4.

The interior surface of the shoot restraint or the plant embryo, or both, may be contacted with the hydrated gel before or after inserting the plant embryo into the shoot restraint. In some embodiments, the interior surface of the shoot restraint is contacted with a hydrated gel before inserting the plant embryo into the shoot restraint. Thus, the interior surface of the shoot restraint may be contacted with a hydrated gel solution that will cure to form a hydrated gel, as described in EXAMPLES 2-4. A cavity may then be made into the hydrated gel in the shoot restraint and the plant embryo inserted into the cavity in the hydrated gel in the shoot restraint, as described in EXAMPLES 2-4. In addition or alternatively, at least a portion of plant embryo may be contacted with a hydrated gel solution that will cure to form a hydrated gel before inserting the plant embryo into the shoot restraint, as described in EXAMPLES 2-4.

In some embodiments, the interior surface of the shoot restraint and/or the plant embryo may be contacted with the hydrated gel after the plant embryo is inserted into the shoot restraint. For example, a hydrated gel solution may be added to the shoot restraint after the plant embryo is inserted into the shoot restraint.

The shoot restraint may be inserted into the seed coat comprising the nutritive medium before or after inserting the plant embryo into the shoot restraint. The manufactured seeds may then be cultured under conditions suitable for germination of the plant embryo. Conditions suitable for germination of manufactured seeds are standard in the art, and include conditions suitable for germination of natural seeds. For example, the manufactured seeds may be sown in any of a variety of environments, such as in sand, vermiculite, sterile soil, and/or in the field (natural soil). For example, sterile Coles™ washed sand, which is available from a variety of gardening supply stores, may be used. Exemplary conditions suitable for germination of the plant embryo in manufactured seeds are described in EXAMPLE 1.

The methods of the invention improve the germination of manufactured seeds. For example, contacting the interior surface of the shoot restraint or the plant embryo with a hydrated gel increased the percentage of normal germinants compared to an otherwise identical method in which neither the shoot restraint nor the plant embryo was contacted with a hydrated gel, as shown in EXAMPLES 2-4.

The term “normal germinant” or “normalcy” denotes the presence of all expected parts of a plant at time of evaluation. The expected parts of a plant may include a radicle, a hypocotyl, one or more cotyledon(s), and an epicotyl. The term “radicle” refers to the part of a plant embryo that develops into the primary root of the resulting plant. The term “cotyledon” refers generally to the first, first pair, or first whorl (depending on the plant type) of leaf-like structures on the plant embryo that function primarily to make food compounds in the seed available to the developing embryo, but in some cases act as food storage or photosynthetic structures. The term “hypocotyl” refers to the portion of a plant embryo or seedling located below the cotyledons but above the radicle. The term “epicotyl” refers to the portion of the seedling stem that is above the cotyledons. In the case of gymnosperms, normalcy is characterized by the radicle having a length greater than 3 mm and no visibly discernable malformations compared to the appearance of embryos germinated from natural seed. It is important to note that, as long as all parts of an embryo have germinated, the corresponding germinant probably has the potential to become a normal seedling. There is no reason to believe that any malformations observed in EXAMPLES 2-4 below are fatal to germinants. Noting the quantity and quality of malformation is a convenient way to comparatively evaluate the various methods and means employed for making manufactured seeds. Fortunately, plant embryonic tissue is exquisitely sensitive to non-natural conditions and manifests that sensitivity in ways discernable to a trained observer.

The following examples merely illustrate the best mode now contemplated for practicing the invention, but should not be construed to limit the invention.

### EXAMPLE 1

This Example shows a general method for assembling plant embryos into manufactured seeds and germinating manufactured seeds.

Representative methods used for making manufactured seeds are described in U.S. Pat. Nos. 6,119,395, 5,701,699, and 5,427,593, incorporated herein by reference. Seed coats were made by plunging paper straw segments into a molten wax formulation. The segments were removed, excess wax drained and the remaining wax allowed to solidify. Ceramic shoot restraints were made by injecting a porcelain slip into a preformed mold with a pin in the center to create the shoot accepting cavity. The slip was allowed to dry to a consistency that allowed removal of the preformed restraint. The restraint was subsequently heated to a temperature that allows the porcelain to form a porous, but fused structure. The restraint was then acid washed to remove impurities. Lids were made by pre-stretching Parafilm™ (Pechiney Plastic Packaging, Chicago, Ill. 60631).

The nutritive medium NM1 (see Table 1) was prepared from pre-made stocks. The required amount of each stock solution (that is not heat-labile) was added to water. Non-stock chemicals (such as charcoal, and agar) were weighed out and added directly to the solution. After all the non-heat-labile chemicals and compounds were added, the medium was brought up to an appropriate volume and the pH was adjusted. The medium was then sterilized by autoclaving. Filter-sterilized heat-labile components (such as sucrose, amino acids, and vitamins) were added after the medium had cooled.

Manufactured seed were assembled by placing a cotyledon restraint on a flat “puck” . A pre-made seedcoat was then placed over the restraint and the unit dipped in molten wax to seal the two units together. The wax was then allowed to solidify and the resulting seedcoat was filled with nutritive medium via a positive displacement pump. The nutritive media was then allowed to solidify and the seed was removed from the flat “puck” . The open end (non-embryo containing end) was then sealed by dipping in molten wax. After the plant embryos were inserted into the shoot restraints, as described in EXAMPLES 2-4, the seeds were sealed by laying lids over the open end of the manufactured seed and fusing the lids to the surface with heat. The manufactured seeds were then swabbed with anti-microbial agents.

A suitable amount of sterile sand was prepared by baking 2 liters of sand at a temperature of 375° F. for 24 hours. The sand was then added to pre-sterilized trays and 285 ml water was added. Furrows were then formed and the box was sealed. The box containing the sand was then autoclaved for 1 hour at 121° C. and 1 atmospheric pressure.

The manufactured seeds were sown in the sand and allowed to germinate. Typically, the manufactured seeds were cultured under continuous light at room temperature (23° C.) for four to five weeks.

TABLE 1
Composition of Media for Manufactured Seeds

| Constituent | NM1 (mg/l) | NM2 (mg/l) | HG1 (mg/l) |
|---|---|---|---|
| NH₄NO₃ | 301.1 | 206.25 | |
| (NH₄)₂MoO₄ | 0.06 | | |
| KNO₃ | | 1170 | |
| MgSO₄.7H₂O | 1000 | 185 | |
| KH₂PO₄ | 1800 | 85 | |
| CaCl₂.2H₂O | 299.2 | 220 | |
| KI | | 0.415 | |
| H₃BO₃ | 10.0 | 3.1 | |
| MnSO₄.H₂O | | 8.45 | |
| MnCl₂.4H₂O | 6.0 | | |
| ZnSO₄.7H₂O | 0.8 | 4.3 | |
| Na₂MoO₄.2H₂O | | 0.125 | |
| CuSO₄.5H₂O | | 0.0125 | |
| CuCl₂.2H₂O | 0.5 | | |
| CoCl₂.6H₂O | | 0.0125 | |
| FeSO₄.7H₂O | | 13.925 | |
| Ferric citrate | 60 | | |
| Na₂EDTA | | 18.625 | |
| Nicotinic acid | 1 | 0.5 | |
| Pyridoxine.HCl | 0.25 | 0.5 | |
| Thiamine.HCl | 1 | 1 | |
| Glycine | | 2 | |
| Myo-Inositol | 100 | 100 | |
| Riboflavin | 0.125 | | |
| Ca-pantothenate | 0.5 | | |
| Biotin | 0.001 | | |
| Folic Acid | 0.125 | | |
| L-asparagine | 106.7 | | |
| L-glutamine | 266.7 | | |
| L-lysine.2H₂O | 53.3 | | |
| DL-serine | 80 | | |
| L-proline | 53.3 | | |
| L-arginine.HCl | 2266.7 | | |
| L-valine | 53.3 | | |
| L-alanine | 53.3 | | |
| L-leucine | 80 | | |
| L-threonine | 26.7 | | |
| L-phenylalanine | 53.3 | | |
| L-histidine | 26.7 | | |
| L-tryptophan | 26.7 | | |
| L-isoleucine | 26.7 | | |
| L-methionine | 26.7 | | |
| L-glycine | 53.3 | | |
| L-tyrosine | 53.3 | | |
| L-cysteine | 26.7 | | |
| Urea | 800 | | |
| Sucrose | 50 | 50 | |
| Agar | 18 | 18 | 18 |
| Charcoal | 2.5 | 2.5 | 2.5 |

pH adjusted to 5.7

### EXAMPLE 2

This Example shows a representative method of the invention for improving the germination of manufactured seeds containing loblolly pine zygotic embryos.

During germination of conifer embryos, the cotyledons have been found to be the primary nutrient uptake organs during germination (Brown & Gifford (1958) Plant Physiol. 33:57-64). Theoretically, the whole surface area of the cotyledons that is available for nutrient uptake in natural seeds because the female gametophyte, which is the source of nutrients, conforms tightly around the cotyledons of the zygotic embryo. In manufactured seeds, the surface area available for nutrient uptake is limited to the area of the cotyledons that is in direct contact with the interior walls of the shoot restraint. Therefore, creating a film of hydrated gel at the interface of the cotyledons and the shoot restraint may increase the surface area available for the uptake of nutrients, thereby improving germination and organ elongation.

Methods: Loblolly pine seeds were surface-sterilized by methods similar to those previously described (Cyr et al. (1991) Seed Sci. Res. 1:91-97). Zygotic embryos were dissected by first cracking open the seedcoat to remove it, then removing undamaged embryo from the megagametophyte with scalpel and forceps in a laminar flow hood. Manufactured seeds were assembled as described in EXAMPLE 1. On the day of dissection, embryos were subjected to the following treatments:

1. Embryos were inserted directly into shoot restraints;

2. Shoot restraints were filled with hydrated gel solution HG1 (Table 1) at 40-45° C. using a 100 microliter pipette, the gel was allowed to set for 1-2 minutes, a cavity was cored into the gel in each shoot restraint using a vacuum flask attached to a 50 microliter pipette, and embryos were inserted into the cavities;

3. Shoot restraints were filled with hydrated gel solution NM1 (Table 1) at 40-45° C. using a 100 microliter pipette, the gel was allowed to set for 1-2 minutes, a cavity was cored into the gel in each shoot restraint using a vacuum flask attached to a 50 microliter pipette, and embryos were inserted into the cavities;

4. Embryos were inserted into shoot restraints after which hydrated gel solution HG1 at 40° C. was added;

5. Embryos were inserted into shoot restraints after which hydrated gel solution NM1 at 40° C. was added;

6. Cotyledons of embryos were dipped into hydrated gel solution HG1 at 40° C. and then inserted into shoot restraints; and

7. Cotyledons of embryos were dipped into hydrated gel solution NM1 at 40° C. and then inserted into shoot restraints.

There were 6 replicates for each treatment, and 5 seeds were used for each replicate. For treatments 2 and 3, all visible hydrated gel was removed by coring in about ⅔ of the manufactured seeds. The manufactured seeds were sealed and germinated as described in EXAMPLE 1.

Results: The percentages of normal germinants as assessed at day 40 after sowing are shown in Table 2. Normalcy refers to the presence of all expected parts of a plant (i.e., radicle, hypocotyl, cotyledon(s), epicotyl) at the time of evaluation. A normal germinant was defined as having a radicle with a length greater than 3 mm and no visibly discernable malformations compared to the appearance embryos germinated from natural seed.

TABLE 2
Percentages of Normal Germinants

| | | Normal |
|---|---|---|
| Treatment | | α = 0.0229¹ |
| | 1 | 63.3%^{A,B} |
| | 2 | 70.0%^{A,B} |
| | 3 | 60.0%^{A,B} |
| | 4 | 46.7%^{B} |
| | 5 | 56.7%^{A,B} |
| | 6 | 72.5%^{A,B} |
| | 7 | 83.3%^{A} |

¹Means followed by the same letter not significantly different.

These results indicate that providing a hydrated gel between the shoot restraints and embryos may improve the germination of manufactured seeds, possibly by increasing the area of the embryo available for nutrient uptake. For example, encasing the cotyledons in hydrated gel increased the percentage of normal germinants by about 9-20% compared to the untreated controls.

### EXAMPLE 3

This Example shows a representative method of the invention for improving the germination of manufactured seeds containing Douglas-fir somatic embryos.

Methods: Manufactured seeds were assembled as described in EXAMPLE 1. Douglas-fir somatic embryos were obtained as previously described (see, e.g., U.S. Pat. Nos. 5,036,007; 5,041,382; 5,236,841; 5,294,549; 5,482,857; 5,563,061 and 5,821,126). After cold treatment, somatic embryos were placed on medium NM2 (Table 1) containing 8 g/l of agar and 20 g/l of sucrose for 20 hours before being subjected to the following treatments:

1. Somatic embryos were inserted into the shoot restraints of manufactured seeds;

2. The shoot restraints were filled with 10 microliters of hydrated gel solution NM1 (Table 1) at 40-50° C. using a Rainin autopipettor, the gel was allowed to set, a as cored the gel in each shoot restraint using a vacuum flask attached to a Pasteur and a somatic embryo was inserted into each cavity; and

3. The cotyledons of embryos were dipped into hydrated gel solution NM1 at about 41° C. before the somatic embryos were inserted into the shoot restraints.

There were 6 replicates for each treatment and 10 seeds were used for each replicate. The manufactured seeds were sealed and germinated as described in EXAMPLE 1.

Results: At all time points examined after showing, the percentage of fully germinated embryos was higher for manufactured seeds after treatments 2 and 3 than after treatment 1, as shown in Table 3.

TABLE 3
Percentages of Fully Germinated Embryos

| Days Past | Percentage of Fully Germinated Embryos | | |
|---|---|---|---|
| Sowing | Treatment 1 | Treatment 2 | Treatment 3 |
| 10 | 0.0% | 1.6% | 3.3% |
| 12 | 0.0% | 1.6% | 5.0% |
| 14 | 0.0% | 5.0% | 8.3% |
| 17 | 1.6% | 6.6% | 16.6% |
| 19 | 6.7% | 10.0% | 21.6% |
| 26 | 11.7% | 28.3% | 30.0% |
| 28 | 16.7% | 31.7% | 30.0% |
| 31 | 16.7% | 33.3% | 31.7% |
| 35 | 20.0% | 38.0% | 33.0% |
| 39 | 21.7% | 41.7% | 33.3% |
| 42 | 25.0% | 41.7% | 33.3% |
| 45 | 25.0% | 41.7% | 33.3% |
| 47 | 25.0% | 41.7% | 33.3% |
| 55 | 25.0% | 41.7% | 33.3% |

Table 4 shows the percentages of normal germinants as assessed at 55 days past sowing. Normalcy refers to the presence of all expected parts of a plant (i.e., radicle, hypocotyl, cotyledon(s), epicotyl) at time of evaluation. A normal germinant was defined as having a radicle with a length greater than 3 mm and no visibly discernable malformations compared to the appearance of embryos germinating from natural seed.

TABLE 4
Percentages of Normal Germinants

| Treatment | Normal |
|---|---|
| 1 | 21.7% |
| 2 | 40.0% |
| 3 | 43.3% |

These results indicate that encasing the cotyledons in hydrated gel (treatment 3) or filling the restraint with hydrated gel (treatment 2) improves the germination of manufactured seeds containing these somatic embryos compared to manufactured seeds containing control embryos (treatment 1), probably by increasing nutrient availability. For example, dipping cotyledons in hydrated gel solution improved normalcy by about 21%, and filling the restraint with hydrated gel solution improved normalcy by about 18% compared to controls. The radicles of germinants from treatment 2 and 3 were also significantly longer than the radicles of germinants from treatment 1.

### EXAMPLE 4

This Example shows a representative method of the invention for improving the germination of manufactured seeds containing loblolly pine somatic embryos.

Methods: Manufactured seeds were assembled as described in Example 1. Loblolly pine somatic embryos were obtained as previously described (see, e.g., U.S. Pat. Nos. 4,957,866; 5,034,326; 5,036,007; 5,041,382; 5,236,841; 5,563,061 and 5,821,126). After cold treatment, somatic embryos were placed on medium NM2 (Table 2) containing 8 g/l of agar and 20 g/l of sucrose for 20 hours before being subjected to the following treatments:

1. Somatic embryos were inserted into shoot restraints;

2. Shoot restraints were filled with 10 microliters of hydrated gel solution NM1 (Table 1) at 40-50° C. using a Rainin autopipettor, the gel was allowed to set, a cavity was cored the gel in each shoot restraint using a vacuum flask attached to a Pasteur pipette, and a somatic embryo was inserted into each cavity; and

3. The cotyledons of somatic embryos were dipped into hydrated gel solution NM1 at about 41° C. before the embryos were inserted into the shoot restraints.

There were 4 replicates for each treatment using loblolly pine somatic embryos. Ten seeds were used for each replicate. The manufactured seeds were sealed and germinated as described in EXAMPLE 1.

Results: The percentages of manufactured seeds in four germination categories was assessed at 48 days past sowing. Overall, the percentage of full extractions were low from manufactured seeds using all treatments in this experiment. However, the percentage of full germinations was 50% higher from manufactured seeds after treatments 2 and 3 than after treatment 1.

While the preferred embodiment of the invention has been illustrated and described, it will be appreciated that various changes can be made therein without departing from the spirit and scope of the invention.

1. A method for improving germination of a manufactured seed, comprising inserting a plant embryo having a shoot end into a shoot restraint comprising an interior surface, wherein at least one of the interior surface of the shoot restraint and the plant embryo is contacted with a hydrated gel before or after inserting the plant embryo into the shoot restraint.

2. The method of claim 1, at least one of the interior surface of the shoot restraint and the plant embryo is contacted with a hydrated gel before inserting the plant embryo into the shoot restraint.

3. The method of claim 2, wherein the interior surface of the shoot restraint is contacted with the hydrated gel before inserting the plant embryo into the contacted shoot restraint.

4. The method of claim 3, comprising the steps of:
(a) adding a liquid hydrated gel solution to the interior surface of the shoot restraint;
(b) allowing the liquid hydrated gel solution to set;
(c) coring a cavity into the hydrated gel; and
(d) inserting the plant embryo into the cavity in the hydrated gel.

5. The method of claim 2, wherein at least part of the plant embryo is contacted with the hydrated gel before inserting the plant embryo into the shoot restraint.

6. The method of claim 5, wherein only the shoot end of the plant embryo is contacted with the hydrated gel.

7. The method of claim 6, wherein the cotyledons of the plant embryo are contacted with the hydrated gel.

8. The method of claim 7, comprising the steps of:
(a) contacting the cotyledons of a plant embryo with a liquid hydrated gel solution;
(b) allowing the liquid hydrated gel solution to set; and
(c) inserting the contacted plant embryo into the shoot restraint.

9. The method of claim 1, at least one of the interior surface of the shoot restraint and the plant embryo is contacted with a hydrated gel after inserting the plant embryo into the shoot restraint.

10. The method of claim 1, wherein the hydrated gel comprises nutrients for the plant embryo.

11. The method of claim 1, wherein the plant embryo is a somatic embryo.

12. The method of claim 11, wherein the plant somatic embryo is a conifer somatic embryo.

13. The method of claim 11, wherein the plant somatic embryo is a Douglas-fir somatic embryo.

14. The method of claim 11, wherein plant somatic embryo is a loblolly pine somatic embryo.

15. A manufactured seed comprising a shoot restraint and a plant embryo having a shoot end, wherein at least the shoot end of the plant embryo is disposed within the shoot restraint and wherein a hydrated gel is disposed between the shoot restraint and the plant embryo.

16. The manufactured seed of claim 15, wherein the hydrated gel comprises nutrients for the plant embryo.

17. The manufactured seed of claim 15, wherein the plant embryo is a somatic embryo.

18. The manufactured seed of claim 15, wherein the plant somatic embryo is a Douglas-fir somatic embryo.

19. The manufactured seed of claim 15, wherein the plant somatic embryo is a loblolly pine somatic embryo.
